(19) United States
(12) Patent Application Publication
(10) Pub. No.: US 2025/0286273 A1
(43) Pub. Date: Sep. 11, 2025

(54) MULTI-TAPERED COAXIAL BALUN

(71) Applicants: Kyle Patrick McParland, Newark, DE (US); Mark Mirotznik, Newark, DE (US)

(72) Inventors: Kyle Patrick McParland, Newark, DE (US); Mark Mirotznik, Newark, DE (US)

(73) Assignee: University of Delaware, Newark, DE (US)

(21) Appl. No.: 18/858,541

(22) PCT Filed: Apr. 20, 2023
(86) PCT No.: PCT/US2023/019225

§ 371 Date: Oct. 21, 2024

Related U.S. Application Data
(60) Provisional application No. 63/333,259, filed on Apr. 21, 2022.

(51) Int. Cl. H01Q 1/50; H01P 5/10; H01Q 1/38

(52) U.S. Cl. CPC H01Q 1/50; H01P 5/10; H01Q 1/38

(57) ABSTRACT

A multi-tapered coaxial balun for use with an antenna includes a coaxial transmission line including an inner conductor, an outer conductor, and a tapered slot provided within the outer conductor. At least one of the inner conductor or the outer conductor is tapered.

### CROSS-REFERENCE TO RELATED APPLICATIONS

This application claims the benefit of U.S. Provisional Patent Application Ser. No. 63/333,259, titled “MULTI-TAPERED COAXIAL BALUN,” filed Apr. 21, 2022. The entirety of the aforementioned application is herein incorporated by reference.

### GOVERNMENT RIGHTS

This invention was made with government support under contract number N00014-21-1-2252 awarded by the Office of Naval Research, United States Department of the Navy. The government has certain rights in the invention.

### FIELD OF THE INVENTION

This disclosure relates generally to impedance transformers, and more specifically, to impedance transforming coaxial baluns for use with antennas.

### BACKGROUND OF THE INVENTION

A balun is an electrical or electromagnetic device that allows interfacing between a balanced port (e.g., antenna) and an unbalanced port (or transmission line), such as an unbalanced coaxial transmission line connecting the antenna to an RF device, such as a receiver, a transmitter, a transceiver, a low-noise amplifier (LNA), etc., for example. Impedance transforming baluns are used in a wide range of RF and microwave devices and systems to perform two general functions. First, as its name indicates (i.e., from balanced to unbalanced or “balancing unit”), the balun converts signals from a balanced port to an unbalanced port, and vice versa. Second, because the impedances of the balanced and the unbalanced ports are generally not matched, the balun performs impedance transformation. For many modern applications, such as wireless communications, for example, the balun may be tasked to accomplish both functions efficiently over a wide frequency bandwidth.

Impedance transforming baluns are used in various applications, such as broadband radio frequency (“RF”) antenna structures (e.g., spiral antennas), and commercial applications, such as RADAR radiolocation systems and communication systems. Planar baluns are common due to the prevalence of planar microwave integrated circuit technology. However, there are many applications in which nonplanar geometries, such as coaxially tapered baluns, for example, are preferred.

There are many applications in which nonplanar geometries, such as coaxial baluns, for example, are preferred.

To this end, several wideband coaxial balun designs have been proposed, including the Marchand balun and coaxially tapered baluns. The Marchand balun consists of a coaxial cavity that acts as a resonant shunt at the junction between an unbalanced coaxial input feed and a balanced two-conductor device. While providing good wideband operation, this design is often complex and not easily amenable to advanced fabrication methods, such as additive manufacturing (“AM”), for example.

The coaxially tapered balun was first explored by Duncan and Minerva as early as 1959. See J. W. Duncan and V. P. Minerva, “100:1 Bandwidth BalunTransformer,” in Proceedings of the IRE, vol. 48, no. 2, pp. 156-164, February 1960. The Duncan and Minerva device transitioned from a coaxial feed to a two-conductor balanced configuration by slitting the outer conductor of the coaxial line and gradually decreasing the material in the outer conductor until an open, two-conductor line, is achieved. As illustrated in FIG. 1, for example, a coaxial transmission line 10, which includes an inner conductor 102 and an outer conductor 104, can be converted from an unbalanced coaxial line to a two-conductor balanced system, by forming a tapered slot 106 within the outer conductor 104 of the coaxial line 10. The resulting balun 10 in FIG. 1 provides an impedance matching transition from an unbalanced coaxial line to a balanced, open, two-conductor line. The characteristic impedance, z, is controlled along the length L of the balun 10 by varying the angle, θ, or the width, of the slot 106. The Duncan and Minerva tapered balun is suitable for broadband, balanced antennas, such as spirals and sinuous antennas, for example. However, its geometry only allows for tapering of a slot formed within the outer conducting shield (e.g., the outer conductor 104) of the coaxial transmission line. The diameters “2a” and “b” of the inner conductor 102 and the outer conductor 104, respectively, are fixed.

Since the original Duncan and Minerva coaxially tapered balun, efforts have been made to expand on the tapered slot design approach to show the possibility of realizing impedance matching baluns with over a 100:1 bandwidth. One challenge with this design approach is the difficulty of fabricating a precisely tapered outer shell. Subtractive manufacturing methods (e.g., cutting, milling, etc.) were originally used to remove the outer conductor of the coaxial line to form the tapered slot. However, more recently, advanced manufacturing methods, such as additive manufacturing (“AM”), for example, have been proposed. Specifically, stereolithography (“SLA”), as described in J. Haumant, R. Allanic, C. Quendo, D. Diedhiou, A. Manchec, C. Person, and R-M Sauvage, “Ultra-Wideband Transition from Coaxial Line to Two Parallel Lines Manufactured Using Additive Manufacturing Technology,” 2019 IEEE MTT-S International Microwave Symposium (IMS), 2019, pp. 1217-1220, for example, can be used to print the tapered geometry, shown in FIG. 1, for example, with a polymer resin that is subsequently metalized via electroplating.

Advancements in the area of balun antenna systems are continually sought in the interests of design flexibility, advanced fabrication methods, performance, cost, and operability. A need remains for an improved balun design that allows variations of at least one, or both, of the inner and outer conductor dimensions, as well as the slot width, while achieving a wide range of impedance ratios, satisfying geometrical constraints, and reducing transmission losses.

### SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention or to delineate the scope of the invention. The sole purpose of the summary is to present some concepts in a simplified form as a prelude to the more detailed description that is presented later.

According to an aspect of the invention, a multi-tapered coaxial balun for use with an antenna includes a coaxial transmission line including an inner conductor, an outer conductor, and a tapered slot provided within the outer conductor. At least one of the inner conductor or the outer conductor is tapered.

At least one of the inner conductor or the outer conductor may be tapered at a respective end of the inner conductor or the outer conductor facing the antenna. A dielectric material may be provided between the inner conductor and the outer conductor.

In embodiments, both the inner conductor and the outer conductor may be tapered, such as both the inner conductor and the outer conductor may be tapered at respective ends of the inner conductor and the outer conductor facing the antenna.

A slot taper of the tapered slot and respective taper of the at least one of the inner conductor or the outer conductor may be configured to produce an impedance matching between an unbalanced end of the coaxial transmission line and the antenna along a length of the balun. The impedance matching may be achieved by varying a cross-sectional geometry of at least one of the inner conductor or the outer conductor the length of the balun. The balanced-to-unbalanced impedance ratio may be greater than 5:1.

The inner conductor may have a gradually narrowing conical frustum shape comprising a first radius at a first end of the inner conductor, a second radius at a second end of the inner conductor, and varying radii along a length of the inner conductor, wherein the first radius is larger than the second radius. The gradually narrowing conical frustum shape may further comprise a third radius at a first end of the outer conductor, a fourth radius at a second end of the outer conductor, and varying radii along a length of the outer conductor, wherein the third radius is larger than the fourth radius. The third radius may be larger than the first radius. The fourth radius may be larger than the second radius.

A feed gap may be located between the second end of the inner conductor and the second end of the outer conductor.

A first end of the outer conductor may comprise a circular arc with an arc dimension equal to a diameter of the outer conductor minus a dimension of the slot. A space between the inner conductor and the circular arc may be filled with a dielectric material. A first end of the inner conductor may have a first radius and the circular arc of the outer conductor may have a second radius with a half angle. The tapered slot may have the second radius with a slot angle. The tapered slot may comprise a removed portion of the outer conductor, the removed portion comprising the slot angle.

The cross-sectional dimensions of the inner conductor and the outer conductor may vary along respective lengths of the inner conductor and the outer conductor, the spacing between the inner conductor and the outer conductor may vary along respective lengths of the inner conductor and the outer conductor, or a combination thereof. The inner conductor and the outer conductor may be separated by a dielectric material, wherein a characteristic impedance of the balun depends on a cross-sectional geometry along a length of the balun and a permittivity of the dielectric material.

The inner conductor and the outer conductor may be separated by a dielectric material, and a characteristic impedance along a length of the balun may depend on a ratio of a radius of the outer conductor to a radius of the inner conductor, a ratio of a thickness of the outer conductor to the radius of the inner conductor, an arc angle of the outer conductor, and a permittivity of a material between the inner conductor and the outer conductor.

The slot taper of the tapered slot and the respective taper of the at least one of the inner conductor or the outer conductor may be selected by using an impedance profile, such as a Klopfenstein impedance profile or an exponential impedance profile.

According to another aspect of the invention, an antenna device includes an antenna substrate, an antenna, a SubMiniature version A (“SMA”) connector, and a multi-tapered coaxial balun including an inner conductor, an outer conductor, and a tapered slot provided within the outer conductor. At least one of the inner conductor or the outer conductor is tapered. The multi-tapered coaxial balun and the SMA connector may be printed vertically on a bottom surface of the antenna substrate. The multi-tapered coaxial balun and the SMA connector may be electrically connected to the antenna through vias. The respective ends of the inner conductor and the outer conductor may be electrically connected to respective feed points of the antenna. A feed gap may be provided between the respective ends of the inner conductor and the outer conductor connected to respective feed points of the antenna.

According to another aspect of the invention, a method for producing an antenna device includes printing an antenna on a first surface of an antenna substrate, printing a multi-tapered coaxial balun and a SubMiniature version A (“SMA”) connector on a second surface of the antenna substrate, which is opposite the first surface of the antenna substrate, and electrically connecting the multi-tapered coaxial balun and the SMA connector to the antenna. The multi-tapered coaxial balun includes an inner conductor, an outer conductor, and a tapered slot provided within the outer conductor. At least one of the inner conductor or the outer conductor is tapered.

The method may include filling all conductive regions with conductive inks, filling all dielectric regions with a dielectric material, or a combination thereof. The method may include electrically connecting the multi-tapered coaxial balun and the SMA connector to the antenna through vias formed in the antenna substrate.

The method may include selecting an impedance profile that smoothly transitions from an unbalanced input impedance to a balanced load impedance over a length of the balun, such as a Klopfenstein impedance profile or an exponential impedance profile. After selecting the impedance profile, the method may include determining a specific balun geometry by matching the impedance at each location along a length of the balun to a characteristic impedance of a uniform slotted coaxial transmission line, the characteristic impedance being approximated or calculated numerically.

The method may include combining two identical multi-tapered coaxial baluns facing opposite directions. The method may include continuously linearly varying at least one of a radius of the outer conductor or a radius of the inner conductor along a length of the balun, such as continuously linearly varying a radius of the outer conductor along a length of the balun from 1.8 mm at each end of the balun to 0.9 mm at a center of the balun.

The multi-tapered design of the coaxial balun system described herein includes variations of at least one, or both, of the inner and outer conductor radii, in addition to varying the slot angle, or slot width, within the outer conducting shield. These added degrees of freedom allow the spacing between, and the size of, the inner and outer conductors at the balanced end of the device (e.g., the antenna side) to be controlled independently of the dimensions at the unbalanced end (e.g., an unbalanced coaxial transmission line to an RF device, such as a receiver, a transmitter, a transceiver, a low-noise amplifier (LNA), etc., for example. Such independent control provides a design flexibility allowing the balun to connect to any commercial or custom connectors and antennas. In embodiments, the multi-tapered design of the coaxial balun system described herein is realized using advanced additive manufacturing methods and can achieve a wider range of impedance contrast with balanced-to-unbalanced impedance ratios that range from 1:1 to greater than 5:1 over a wide frequency range.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 is a schematic diagram of a traditional coaxially tapered balun introduced by Duncan and Minerva.

FIG. 2 is a schematic diagram of a triple-tapered balun design, according to an embodiment of the invention.

FIG. 3 is a schematic diagram of a double-tapered balun design, according to an embodiment of the invention.

FIG. 4 is a schematic diagram of an integrated antenna feed that combines a printed connector, a multi-tapered coaxial balun, and a spiral antenna, according to an embodiment of the invention.

FIG. 5 illustrates a cross-sectional geometry and material properties of a uniform slotted coaxial transmission line, according to an embodiment of the invention.

FIG. 6A illustrates plots of the calculated characteristic impedance of the uniform slotted coaxial transmission line of FIG. 5 for a ratio between the thickness “w” of the outer conductor to the radius “a” of the inner conductor w/a=0.

FIG. 6B illustrates plots of the calculated characteristic impedance of the uniform slotted coaxial transmission line of FIG. 5 for a ratio between the thickness “w” of the outer conductor to the radius “a” of the inner conductor w/a=0.25.

FIG. 7A illustrates geometries and calculated tapered slot widths for multi-tapered balun for Klopfenstein and exponential impedance profiles.

FIG. 7B illustrates tapered impedance profiles of the designs of FIG. 7A mapped onto characteristic impedance of a uniform slotted coaxial line.

FIG. 8 is a schematic diagram of a Back-to-Back (“BTB”) balun.

FIG. 9A illustrates a comparison of simulated transmission coefficient magnitudes for exponential versus Klopfenstein taper designs.

FIG. 9B illustrates a comparison of simulated reflection coefficient magnitudes for exponential versus Klopfenstein taper designs.

FIG. 10A is a schematic diagram with dimensions of a traditional coaxially tapered balun introduced by Duncan and Minerva.

FIG. 10B is a schematic diagram with dimensions of a double-tapered coaxial balun configuration, according to an embodiment of the invention.

FIG. 10C is a schematic diagram with dimensions of a triple-tapered coaxial balun configuration, according to an embodiment of the invention.

FIG. 11A illustrates variations in the slot angle, θ(x), for the coaxially tapered balun designs of FIGS. 10A, 10B, and 10C.

FIG. 11B illustrates variations in inner and outer conductor radii, a(x) and b(x), respectively, for the coaxially tapered balun designs of FIGS. 10A, 10B, and 10C.

FIG. 11C illustrates simulated transmission coefficients for the coaxially tapered balun designs of FIGS. 10A, 10B, and 10C.

FIG. 12A illustrates surface current density distribution at 15 GHz for the BTB balun shown in FIG. 10C.

FIG. 12B illustrates amplitude and phase differences of the surface current density between the inner and outer conductors at the center of the BTB balun shown in FIG. 10C.

FIG. 13 illustrates simulated transmission coefficient magnitude of the BTB balun configuration of FIG. 10C for various electrical conductivities of the conductor surfaces.

FIG. 14A illustrates a triple-tapered BTB coaxial balun including printed SMA connectors, according to an embodiment of the invention.

FIG. 14B illustrates a fabricated BTB coaxial balun with integrated connectors, according to an embodiment of the invention.

FIG. 14C illustrates a micro-CT image of a fabricated BTB balun showing the tapered conductive region, according to an embodiment of the invention.

FIG. 15A illustrates a comparison of the simulated and measured S-parameters S11 for the triple-tapered BTB balun of FIG. 14B.

FIG. 15B illustrates a comparison of the simulated and measured S-parameters S21 for the triple-tapered BTB balun of FIG. 14B.

FIG. 16A illustrates a fully integrated feed that combines a multi-tapered coaxial balun with a threaded SMA connector and a spiral antenna, according to an embodiment of the invention.

FIG. 16B illustrates a cross-sectional geometry of the fully integrated feed of FIG. 16A, according to an embodiment of the invention.

FIG. 16C illustrates a top view of the fully integrated feed of FIG. 16A, according to an embodiment of the invention.

FIG. 17A illustrates an additively manufactured integrated antenna feed with a printed antenna (left) and an antenna with added tapered balun and an SMA connector (right), according to an embodiment of the invention.

FIG. 17B illustrates a micro-CT image of the antenna of FIG. 17A.

FIG. 18 illustrates a comparison of the simulated and measured return loss for the integrated balun and spiral antenna of FIGS. 16A and 16B.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE INVENTION

The invention will now be described by reference to exemplary embodiments and variations of those embodiments. Although the invention is illustrated and described herein with reference to specific embodiments, the illustrated examples are not intended to be limited to the details shown and described. Rather, various modifications may be made in the details within the scope and range of equivalents of the claims and without departing from the invention. For example, one or more aspects of the disclosed embodiments can be utilized in other embodiments and even other types of devices. Moreover, certain terminology is used herein for convenience only and is not to be taken as a limitation.

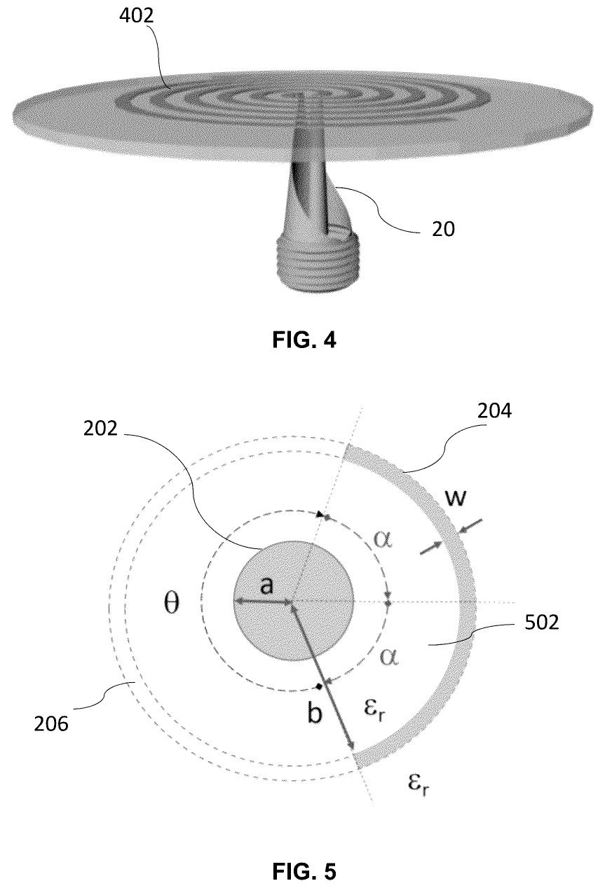

Referring now to FIG. 2, for example, an embodiment of a multi-tapered coaxial balun system 20 for use with an antenna 402 (shown in FIG. 4) is disclosed.

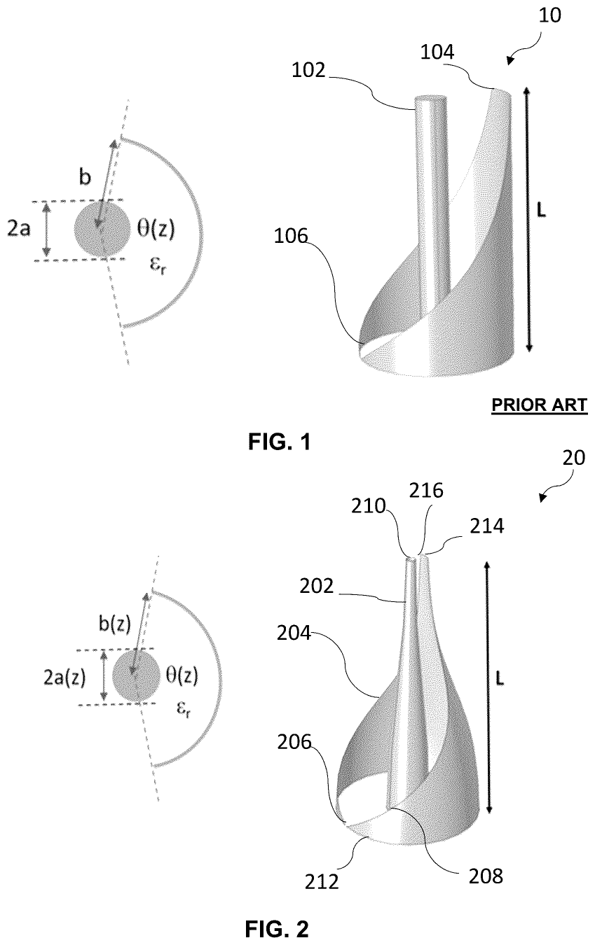

Specifically, the multi-tapered coaxial balun system 20 includes an inner conductor 202 and an outer conductor 204. A tapered slot 206 is provided within the outer conductor 204, similar to the slot 106 in the multi-tapered coaxial balun system 10 in FIG. 1. Unlike FIG. 1, however, in the multi-tapered coaxial balun system 20 illustrated in FIG. 2, both the inner conductor 202 and the outer conductor 204 are tapered, in addition to the tapered slot angle of the tapered slot 206.

The inner conductor 202 in FIG. 2 has a gradually narrowing cylindrical or conical frustum shape. As used herein, the term “gradually narrowing cylindrical or conical frustum shape” of the inner conductor 202 means that the radius “a(x₀)” (“first radius”) at a first end 208 of the inner conductor 202 is larger than the radius “a(x_{L})” (“second radius”) at a second end 210 of the inner conductor 202, while areas between the first end 208 and the second end 210 of the inner conductor 202 have radii that gradually and slowly vary between the radius “a(x₀)” and the radius “a(x_{L})”. In the designations “a(x₀)” and “a(x_{L})”, x₀ is a location along the length L of the balun at the first end 208 of the inner conductor 202 and x_{L} is a location along the length L of the balun at the second end 210 of the inner conductor 202.

Similarly, the outer conductor 204 in FIG. 2 can also have a gradually narrowing cylindrical or conical frustum shape. As used herein, the term “gradually narrowing cylindrical or conical frustum shape” of the outer conductor 204 means that the radius “b(x₀)” (“third radius”) at a first end 212 of the outer conductor 204 is larger than the radius “b(x_{L})” (“fourth radius”) at a second end 214 of the outer conductor 204, while areas between the first end 212 and the second end 214 of the outer conductor 204 have radii that gradually and slowly vary between the radius “b(x₀)” and the radius “b(x_{L})”. In the designations “b(x₀)” and “b(x_{L})”, x₀ is a location along the length L of the balun at the first end 212 of the outer conductor 204 and x_{L} is a location along the length L of the balun at the second end 214 of the outer conductor 204.

An advantage afforded by the multi-tapered design of the coaxial balun system illustrated in FIG. 2 is that the spacing between, and the size of, the two conductors 202 and 204 at the balanced end of the device (e.g., the antenna side) can be controlled independently of the dimensions at the unbalanced end (e.g., an unbalanced coaxial transmission line to an RF device, such as a receiver, a transmitter, a transceiver, a low-noise amplifier (LNA), etc., for example, thus allowing for wideband transition from standard commercial off-the-shelf coaxial feed lines with fixed dimensions to more general balanced two-conductor antennas. Another advantage is that the same design process can achieve balanced-to-unbalanced impedance ratios that range from 1:1 to greater than 5:1 over a wide frequency range. This is not possible using the original Duncan and Minerva coaxially tapered design (FIG. 1).

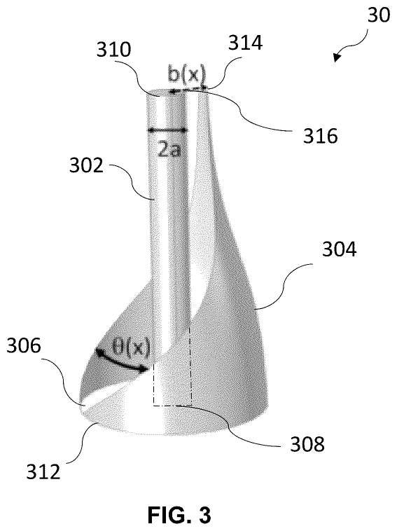

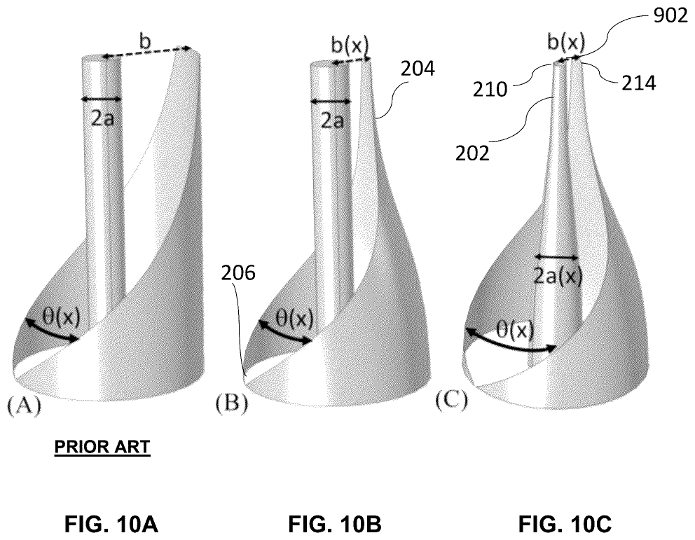

It should be understood that the geometry and the dimensions of the multi-tapered coaxial balun system 20 shown in FIG. 2 may vary, and could have different shapes and configurations, such as the configurations illustrated in FIG. 3 and FIG. 10B, for example.

Referring now to FIG. 3, for example, another embodiment of a multi-tapered coaxial balun system 30 for use with an antenna 402 (shown in FIG. 4) is disclosed. Similar to the embodiment illustrated in FIG. 2, the multi-tapered coaxial balun system includes an inner conductor 302 and an outer conductor 304. A tapered slot 306 is provided within the outer conductor 304, similar to the slots 106 and 206 in the tapered coaxial balun systems 10 and 20 in FIGS. 1 and 2, respectively. Unlike FIG. 1 and FIG. 2, however, in the multi-tapered coaxial balun system 30 illustrated in FIG. 3, only the outer conductor 304 is tapered, in addition to the tapered slot angle of the tapered slot 206, while the inner conductor 302 is not tapered.

The inner conductor 302 in FIG. 3 has a cylindrical shape, without gradually narrowing portions, like the inner conductor 302 in FIG. 2. As used herein, the term “cylindrical shape” of the inner conductor 302 means that the radius “a(x₀)” (“first radius”) at a first end 308 of the inner conductor 302 is the same as the radius “a(x_{L})” (“second radius”) at a second end 310 of the inner conductor 302. All areas between the first end 308 and the second end 310 of the inner conductor 302 have the same radii as the radius “a(x₀)” and the radius “a(x_{L})”. In the designations “a(x₀)” and “a(x_{L})”, x₀ is a location along the length L of the balun at the first end 208 of the inner conductor 202 and x_{L} is a location along the length L of the balun at the second end 310 of the inner conductor 302.

Unlike the inner conductor 302, the outer conductor 304 in FIG. 3 has a gradually narrowing cylindrical or conical frustum shape. As used herein, the term “gradually narrowing cylindrical or conical frustum shape” of the outer conductor 304 means that the radius “b(x₀)” (“third radius”) at a first end 312 of the outer conductor 304 is larger than the radius “b(x_{L})” (“fourth radius”) at a second end 314 of the outer conductor 304, while areas between the first end 312 and the second end 314 of the outer conductor 304 have radii that gradually and slowly vary between the radius “b(x₀)” and the radius “b(x_{L})”. In the designations “b(x₀)” and “b(x_{L})”, x₀ is a location along the length L of the balun at the first end 312 of the outer conductor 304 and x_{L} is a location along the length L of the balun at the second end 314 of the outer conductor 304.

Because the inner conductor 302 in FIG. 3 is not tapered, the distance 316 (or the feed gap) between the second ends 310 and 314 of the inner and outer conductors, respectively, can be larger than the distance 216 (or the feed gap) between the second ends 210 and 214 of the inner and outer conductors, respectively, in FIG. 2. As discussed below with reference to FIG. 10C, the balun design of FIG. 2 offers the lowest transmission loss by a relatively large margin. Without being bound to any particular theory of operation, the inventors believe this is due to the smaller feed gap (or distance) 216 between the second ends 210 and 214 of the inner conductor 202 and the outer conductor 204, respectively, as the slot angle θ increases.

However, embodiments are not limited to the balun designs illustrated in FIG. 2 and FIG. 3, and other configurations are possible. For example, because the characteristic impedance of the balun depends on the ratio of the outer conductor to inner conductor radii, b(x)/a(x), a designer can be free to taper the inner and outer conductors 202 (or 302) and 204 (or 304) to any desirable diameter, assuming that the proper (b/a) ratio is maintained.

Assuming that the characteristic impedance of the balun system 20 depicted in FIG. 2 at any cross section is equal to the characteristic impedance of a uniform, slotted coaxial line of that particular cross section, the broadband impedance matching properties of the multi-tapered coaxial balun system 20 can be achieved by tailoring the cross-sectional geometry of the inner conductor 202 and the outer conductor 204 along their respective lengths, which is also the length L of the balun. The objective is to create a spatially varying characteristic impedance that closely matches an optimized impedance profile chosen to match input and output impedances while minimizing reflected losses over a broad frequency range.

FIG. 5 illustrates a cross-sectional shape of the multi-tapered coaxial balun system 20 depicted in FIG. 2. The inner conductor 202 with a cylindrical or gradually narrowing conical frustum shape. The inner conductor 202 has a radius a and is surrounded by an outer conducting circular arc of the outer conductor 204. The outer conductor 204 has a radius b and a half angle denoted by α. The wall of the outer conductor 204 has a finite thickness denoted by w. For purposes of the tests and simulations described herein, all conductive elements (e.g., the inner conductor 202 and the circular arc of the outer conductor 204) are assumed to be perfect electrical conductors (PECs) that have infinite electrical conductivity or zero resistivity. The space 402 between the inner conductor 202 and the circular arc of the outer conductor 204 is assumed to be filled with a dielectric material having a lossless relative permittivity Er. The slot angle θ in FIG. 5 denotes the portion of the outer conductor 204 that has been removed to form the slot 206.

A transmission line with the cross-sectional geometry shown in FIG. 5 will support a quasi-TEM (Transverse Electric and Magnetic) mode with a characteristic impedance, Zo, that depends on four variables: (1) the ratio of the radius “b” of the outer conductor 204 to the radius “a” of the inner conductor 202 (b/a), (2) the ratio of the thickness “w” of the outer conductor 204 to the radius “a” of the inner conductor 202 (w/a), (3) the arc angle “a” of the outer conductor 204, and (4) the permittivity (Er) of the surrounding material or the material filling the space 402 between the inner conductor 202 and the circular arc of the outer conductor 204. To demonstrate the exact relationship of these four parameters to the characteristic impedance, Zo, the inventors have conducted a comprehensive parametric study using a two-dimensional (“2D”) quasi-static mode solver built into the commercial finite element program COMSOL Multiphysics™. For these simulations, the four parameters described above were varied within the minimum and maximum value ranges provided in Table I below:

TABLE I
DESCRIPTION OF PARAMETERS
USED IN 2D MODE SOLVER

| Parameter | Minimum value | Maximum value |
|---|---|---|
| α | 1 [symbol] | 180 [symbol] |
| b/a | 1.5 | 4.0 |
| w/a | 0 | 0.5 |
| [symbol] | 1.0 | 4.0 |

[symbol]

indicates data missing or illegible when filed

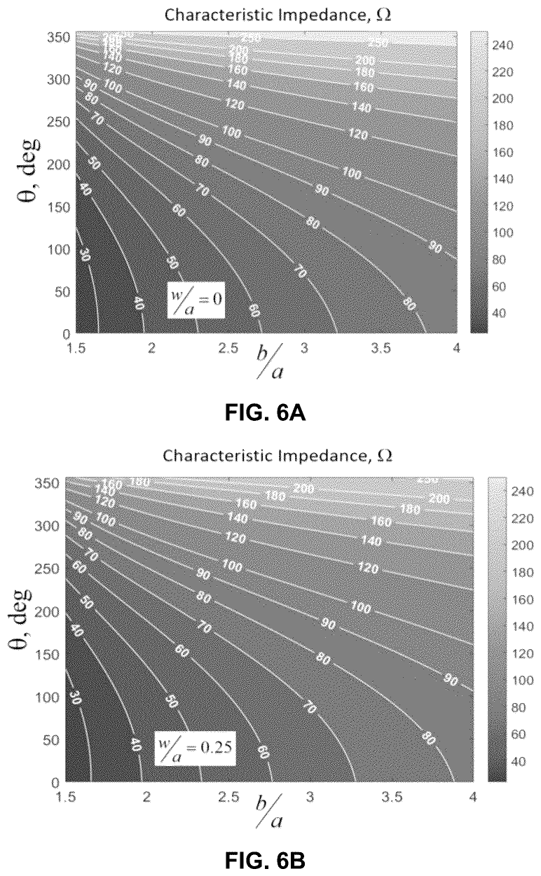

In FIGS. 6A and 6B, the characteristic impedance Zo is plotted as a function of the slot angle θ and the ratio (b/a) of the radius “b” of the outer conductor 204 to the radius “a” of the inner conductor radius 202, for two different ratios (w/a) of the thickness “w” of the outer conductor 204 to the radius “a” of the inner conductor 202. Specifically, FIG. 6A illustrates plots of the calculated characteristic impedance Zo of the uniform slotted coaxial transmission line of FIG. 5 with permittivity of the surrounding material εᵣ=1 for a ratio between the thickness “w” of the outer conductor to the radius “a” of the inner conductor w/a=0. FIG. 6B illustrates plots of the calculated characteristic impedance Zo of the uniform slotted coaxial transmission line of FIG. 5 with permittivity of the surrounding material εᵣ=1 for a ratio between the thickness “w” of the outer conductor to the radius “a” of the inner conductor w/a=0.25. However, embodiments are not limited to these dimensions and dielectric materials, and any other dimensions and dielectric materials can be used.

For the plots illustrated in FIGS. 6A and 6B, free space was assumed to be present between the conductors 202 and 204 (i.e., εᵣ=1). However, when other materials are inserted in the space 402 between the conductors 202 and 204, the impedance Zo scales approximately as

$$\frac{1}{\sqrt{{ε}_{r}}} .$$

Based on these results, an analytical expression shown in Equation (1) below was derived that accurately approximates the impedance Zo of the geometry shown in FIG. 5. This expression was found to have a maximum error less than 5% and a mean error less than 1.5% over the range of values provided in Table I.

$${Z}_{o} ( ξ , {ε}_{r} , \frac{b}{a} , \frac{w}{a} ) \approx \frac{{η}_{o}}{2 π \sqrt{{ε}_{r}}} ln ( \frac{b}{a} ) - \frac{280}{\sqrt{{ε}_{r}}} \cdot \frac{( \frac{D}{a} ) - 1}{4 ( \frac{b}{a} ) - 3} ( 1 - ξ ) \cdot ln ( ξ \frac{9 ( \frac{b}{a} ) - 4}{12 ( \frac{b}{a} ) - 9} ) + \frac{1}{\sqrt{{ε}_{r}}} \cdot \frac{( \frac{b}{a} ) - 1}{2 ( \frac{b}{a} ) - 3} \cdot \frac{cos ( 10 ξ )}{ξ} - \frac{1}{\sqrt{{ε}_{r}}} \frac{( \frac{w}{a} ) \cdot ( 100 - ( \frac{b}{a} ) )}{7 ( \frac{w}{a} ) + 1} \cdot \frac{{e}^{- \frac{15 ( \frac{b}{a} ) - 6}{10 ( \frac{b}{a} ) - 11}}}{\sqrt{ξ}} , \\ where ξ = \frac{σ}{180 °} . \qquad ( 1 )$$

As described below, Equation (1) was used to map a desired impedance profile to a physical balun structure (e.g., shown in FIG. 5).

An initial step in the balun design process is to select an impedance profile that smoothly transitions from an input impedance of Zo to a load impedance of Z_{L} over the length L of the balun, while minimizing the reflected energy over a desired frequency band. For this purpose, the inventors have studied a wide variety of impedance profiles, such as the linear, Gaussian, Klopfenstein, and exponential profiles. While the general balun design approach described herein can be used for any of these profiles or any custom profile, the inventors have found via simulations that the Klopfenstein and the exponential impedance profiles consistently produced the best results. However, embodiments are not limited to these impedance profiles, and any other impedance profiles can be used.

Specifically, the Klopfenstein impedance taper profile is given by Equation (2) below:

$$ln Z ( x ) = \frac{1}{2} ln ( {Z}_{o} {Z}_{L} ) + {Γ}_{m} {A}^{2} Φ ( \frac{2 x}{L} - 1 , A ) \qquad ( 2 )$$

where,

$$A = {cosh}^{- 1} ( \frac{{Γ}_{o}}{{Γ}_{m}} ) , {Γ}_{o} = \frac{1}{2} ln ( \frac{{Z}_{L}}{{Z}_{o}} )$$

and the function ϕ(x, A) is given by Equation (3) below:

$$Φ ( x , A ) = {\int }_{0}^{x} \frac{{I}_{2} ( A \sqrt{1 - {y}^{2}} )}{A \sqrt{1 - {y}^{2}}} dy \qquad ( 3 )$$

where I₁ is a modified Bessel function of the first kind of order one.

The exponential taper impedance profile is given by Equation (4) below:

$$Z ( x ) = {{Z}_{o} ( \frac{{Z}_{L}}{{Z}_{o}} )}^{( \frac{x}{L} )} \qquad ( 4 )$$

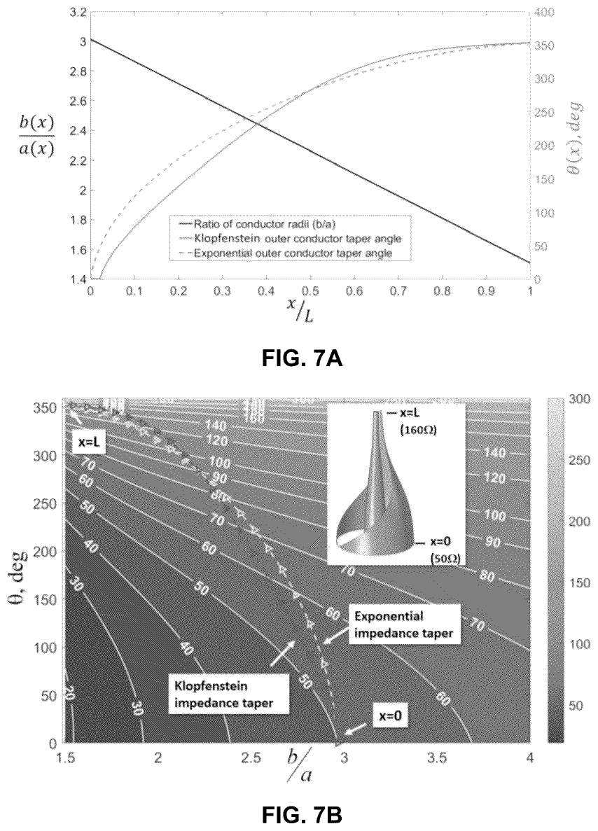

After selecting a desirable impedance profile, a specific balun geometry can be determined by matching the impedance at each location, x, along the length L of the balun to the characteristic impedance of the slotted coaxial transmission line approximated in Equation (1) or calculated numerically. It should be noted that due to the added degrees of freedom of the multi-tapered balun design of FIG. 2, there are an infinite number of different balun geometries that can achieve the same impedance profile. To arrive at a particular geometry, the designer is free to choose some parameters, thus allowing for designs that either adhere to fabrication constraints or force the balun into a desirable geometry (e.g., to match the antenna feed spacing or mate to a commercial connector). As an illustrative example, FIG. 7A illustrates geometries and calculated tapered slot widths for multi-tapered balun designs using both the Klopfenstein impedance profile and exponential impedance profile. For these calculations, the inventors assumed values for the input impedance Zₒ, the load impedance Z_{L}, and the permittivity εᵣ of the surrounding material of respectively Zₒ=50Ω, Z_{L}=160Ω, εᵣ=1.75, and a zero-thickness of the outer conductor 204 (i.e., w=0).

However, embodiments are not limited to these dimensions and dielectric materials, and any other dimensions and dielectric materials can be used. The inventors further forced the ratio of the outer conductor to the inner conductor radii, b(x)/a(x), to decrease linearly along the balun length L, as shown in FIG. 7A. The tapered slot width, θ(x), was then determined using Equation (1) above to match the desired impedance profiles.

FIG. 7B illustrates tapered impedance profiles of the designs of FIG. 7A mapped onto the characteristic impedance of a uniform slotted coaxial line. The resulting balun geometries for both the Klopfenstein and the exponential impedance profiles are illustrated in FIGS. 7A and 7B. Because the characteristic impedance depends on the ratio of the outer conductor to inner conductor radii, b(x)/a(x), a designer can be free to taper the inner and outer conductors 202 and 204 to any desirable diameter, assuming that the proper (b/a) ratio is maintained.

To numerically validate the above-described design approach, the present inventors conducted rigorous electromagnetic modeling using both Back-to-Back (“BTB”) baluns and a balun integrated with a spiral antenna. However, embodiments are not limited to spiral antennas, and any other antennas can be integrated with the balun.

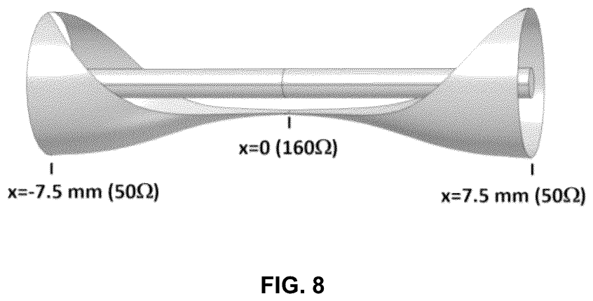

A BTB balun structure is a convenient configuration for evaluating insertion and transmission losses. The basic BTB balun geometry, illustrated in FIG. 8, for example, combines two identical impedance transforming baluns facing opposite directions. For the simulations described herein and summarized in Table II below, the inventors assumed impedance values at each of the two ends and at the center location of the BTB balun structure of 50Ω and 160Ω, respectively, and a half-length of the balun, L/2, of 7.5 mm. This length corresponds to 0.2> at the lowest operational frequency (i.e., 8 GHZ). However, embodiments are not limited to these dimensions and frequency values, and any other dimensions and frequency values can be used.

TABLE II
BACK-TO-BACK BALUN PARAMETERS

| | | |
|---|---|---|
| Parameter | Minimum value | Maximum value |

| Z, Ω | 50 | | 160 | |
|---|---|---|---|---|
| b/a | 1.5 | | 3.0 | |
| a, mm | 0.6 | mm | 0.6 | mm |
| L, mm | 15 | mm | 15 | mm |
| w, mm | 0.6 | mm | 0.6 | mm |

| | | |
|---|---|---|
| f, GHz | 8.0 | 18.0 |
| [symbol] | 1.75 | 1.75 |

[symbol]

indicates data missing or illegible when filed

The radius “a” of the inner conductor 202 was selected to be 0.6 mm, the thickness “w” of the outer conductor 204 was selected to be 0.6 mm, and all dielectric regions were filled with a lossless dielectric of permittivity, εᵣ, equal to 1.75. However, embodiments are not limited to these dimensions and dielectric materials, and any other dimensions and dielectric materials can be used. Both the slot angle, θ(x), and the radius b(x) of the outer conductor 204 were continuously tapered along the length L of the balun. Specifically, b(x) varied linearly from 1.8 mm at each end of the device to 0.9 mm at its center. Lastly, the slot angle θ(x) was calculated using the design process described above to match an exponential and a Klopfenstein impedance distribution.

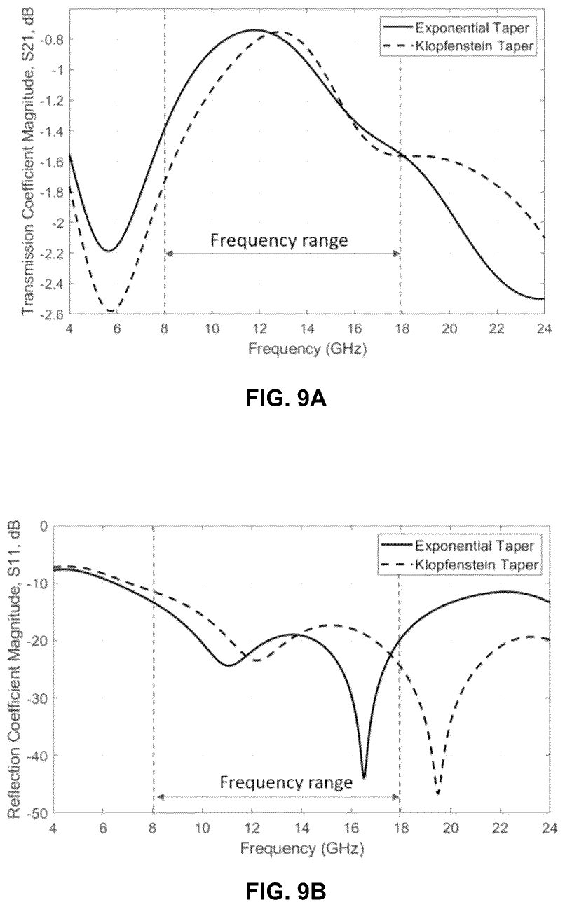

Full S-parameter simulations of the BTB balun structure of FIG. 8 were conducted using an Ansys's High-Frequency Structure Simulator (HFSS), and all conducting surfaces were assumed to be perfect electrical conductors (PECs). Predicted S-parameters for exponential and Klopfenstein taper designs as a function of the frequency are illustrated in FIGS. 9A and 9B. While both designs demonstrated reasonably good impedance matching properties (i.e., |S11|<−10 dB) over the frequency band of interest, 8 GHz to 18 GHz, the exponential impedance profile performed slightly better than the Klopfenstein impedance profile (FIG. 9B). The transmission loss |S21| for the two designs (FIG. 9A) varied from 0.8 dB to 1.6 dB over the same frequency range, 8 GHZ to 18 GHZ. Since these simulations predicted comparable performance for the exponential and Klopfenstein designs, the inventors decided to use the simpler exponential taper design for further computational and experimental validation. However, embodiments are not limited to these impedance profile and frequency ranges, and any other impedance profile and frequency ranges can be used.

It is worth noting that the materials used in the above-described simulations were assumed to be lossless. Thus, the transmission losses, shown in FIG. 9A, are due either to reflection or radiation generated by the excitation of lossy higher order modes. Since reflected losses are relatively low (FIG. 9B), most of the transmission loss can be attributed to radiation. As described below, these transmission losses can be reduced by using a more general triple-tapered balun geometry.

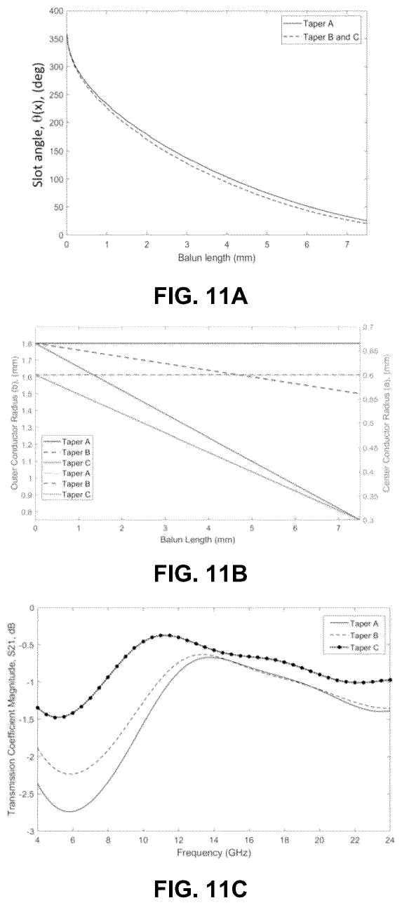

The transmission properties of the three tapered balun geometries discussed above are illustrated side by side in FIGS. 10A-10C. In addition to the original slotted coaxial balun introduced by Duncan and Minerva (shown in FIG. 10A) and the double-tapered design (FIG. 10B), in which both the outer conductor 204 and the slot 206 are tapered, FIG. 10C illustrates a triple-tapered design in which both the inner conductor 202 and the outer conductor 204 are tapered, in addition to the outer conducting slot angle 206. The specific geometrical properties of these three designs are illustrated in FIGS. 11A and 11B. As in the previous example (FIG. 8), the length of the impedance taper was selected to be 7.5 mm resulting in a total BTB balun length L of 15 mm. The dielectric regions were assumed to be filled with a material of permittivity 1.75 and all conducting surfaces were PECs. However, embodiments are not limited to these dimensions and dielectric materials, and any other dimensions and dielectric materials can be used. All three baluns illustrated in FIGS. 10A-10C were designed to match the same exponential impedance profile as described with reference to FIG. 8 above.

The simulated transmission results for all three designs are shown in FIG. 10C. It is important to note that while both tapered configurations (FIGS. 10B and 10C) have improved transmission properties compared to the original slotted-tapered balun design (FIG. 10A), the triple-tapered design of FIG. 10C offers the lowest transmission loss by a relatively large margin. In fact, the maximum transmission loss for the triple-tapered geometry (FIG. 10C) is over 0.5 dB less than the other designs. The inventors believe this is due to the smaller feed gap (or distance) 902 between the second ends 210 and 214 of the inner conductor 202 and the outer conductor 204, respectively, as the slot angle θ increases (FIG. 10C). This geometry results in better coupling of the desired quasi-TEM mode and, as a result, in less energy transitioning to lossy higher order modes. The reflection coefficient, S11, for all three designs in FIGS. 10A-10C was also simulated and found to be less than −15 dB over the entire frequency band of interest, 8 GHz to 18 GHz. However, embodiments are not limited to this frequency band, and the triple-tapered balun geometry (FIG. 10C) can be used for any other frequency ranges.

It is likely that more complex balun geometries can further improve on balun performance. For example, a(x) and b(x) (FIG. 10B) were chosen simply to vary linearly along the balun length for both the double-tapered and the triple-tapered designs. It is feasible to optimize all three tapered profiles shown in FIGS. 10A-10C to minimize transmission loss over a desired frequency band.

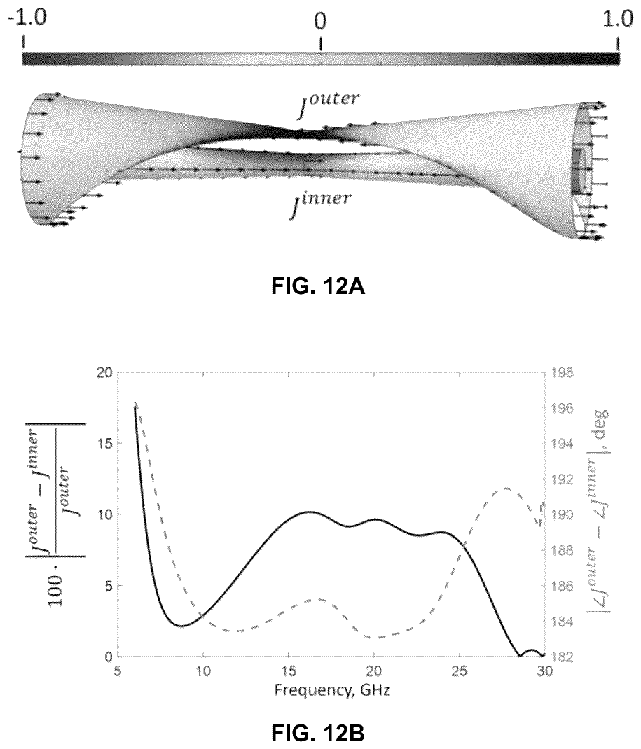

To assess how well the multi-tapered balun balances the current distribution, the present inventors conducted full wave simulations on the BTB balun geometry of FIG. 10C using the commercial software package COMSOL™. FIG. 12A illustrates the surface current density distribution over the inner and outer conductors at 15 GHz. FIG. 12B plots the difference in current amplitude and phase between the inner and outer conductors at the balun's center location as a function of frequency: the current amplitudes vary by at most 10% over the desired frequency band of 8-18 GHZ, while the difference in phase angle varied from 184° to 190° over the same frequency range, 8 GHz to 18 GHz.

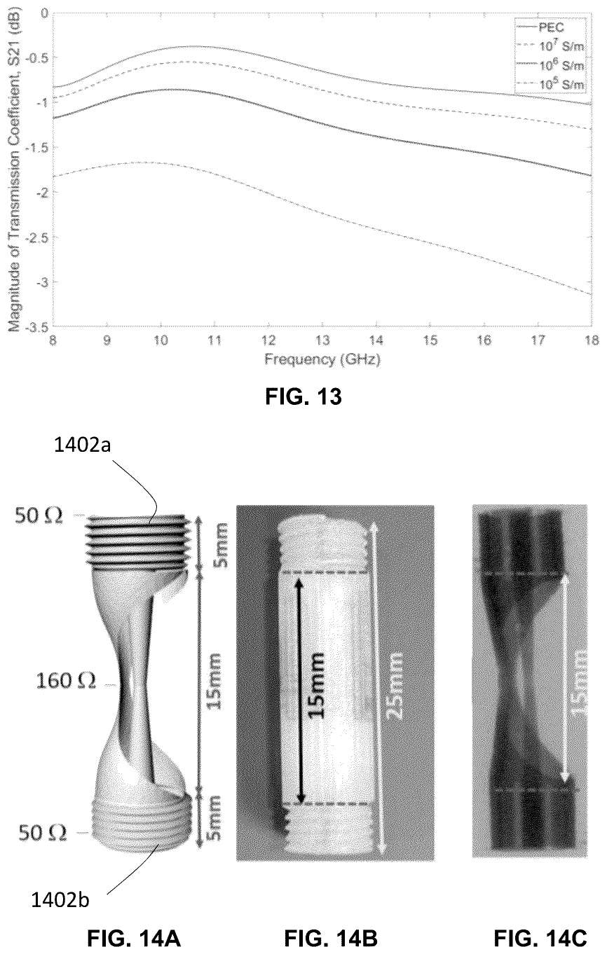

The simulation results described above assumed perfectly conducting surfaces. The present inventors also evaluated the effect of finite conductivity on balun performance. For these simulations, the inventors used the triple-tapered design illustrated in FIG. 10C and varied the electrical conductivity, o, of the surfaces from PEC to 10⁵ S/m. The results, illustrated in FIG. 13, show the expected trend that as the electrical conductivity o decreases the transmission losses increase. It is worth noting that a conductivity commensurate with that of bulk metal, i.e., σ26 10⁷ S/m, leads to transmission losses that are within 0.25 dB of the PEC simulation. However, for less conductive materials, such as the silver-based inks, for example, that are commonly used to additively manufacture prototypes (σ≈10⁶ S/m), there is a notable increase in the transmission loss ranging from 0.4 dB to 0.8 dB [28, 29]. Thus, all simulations described below assume a finite conductivity for conducting surfaces of 10⁶ S/m.

To validate the design approach, the present inventors fabricated and experimentally characterized several prototypes using a multimaterial AM system, materials, manufacturing processes, and experimental results for both the BTB baluns and the fully integrated antennas.

One disadvantage to the multi-tapered configuration of the coaxial balun system illustrated in FIGS. 2 and 3 is the fabrication challenge involved with realizing the three-dimensional (“3D”) geometry of the balun. To address that issue, the present inventors have developed a fabrication process that leverages recent advances in multimaterial AM. Specifically, the inventors have discovered, and demonstrated with tests and simulations, that a single multimaterial printer can reliably manufacture the multi-tapered balun system 20 illustrated in FIGS. 2 and 3, including but not limited to the integration of printed threaded connectors. The inventors have validated their designs experimentally using both back-to-back (“BTB”) baluns and a fully integrated design that includes a printed balun, a SubMiniature version A (“SMA”) connector, and a wideband printed spiral antenna 402 (shown in FIG. 4).

### A. Multimaterial AM System

The AM system used to fabricate all samples was the nScrypt™ Tabletop system. This is a dual deposition 3D printer with one head capable of depositing custom and commercial inks and pastes via micro-dispensing, and another head capable of extruding polymers via Fused Filament Fabrication (FFF). For this application, the inventors used the FFF tool to print all dielectric regions and the micro-dispensing tool to deposit silver pastes for all conductive elements. With these tools, the system is capable of fabricating both conductive and dielectric features as small as 50 μm while maintaining a positional accuracy of less than 1.0 μm.

### B. Materials

For printing of all dielectric regions, the inventors used a polycarbonate filament obtained from matterhackers.com. Electromagnetic material characterization of this filament was previously conducted over a wide band of frequencies (4-40 GHZ) and found that the material was relatively non-dispersive with a dielectric constant of εᵣ=2.68 and a loss tangent of tan δ=0.002. Lower dielectric constants can be achieved via FFF by varying the fill fraction of polymer to air on a subwavelength length scale, so for these samples the inventors adjusted the fill fraction of polycarbonate to achieve an effective permittivity of εᵣ=1.75.

To print all conductive elements, the inventors used nScrypt's micro-dispensing tool to pattern conductive silver inks. Through trial-and-error, the inventors found that the best results were obtained by using a combination of two different conductive inks. Specifically, for all fully encapsulated interior regions, such as the inner and outer conductors, the inventors used a custom conductive ink that incorporated only trace amounts of organic solvents. This ink was found to be ideally suited for filling small channels. For all exterior conductive surfaces, such as the spiral antenna, the inventors used DuPont's KA802. This ink was found to have improved surface adhesion properties making it a more robust choice for any exposed surface.

However, embodiments are not limited to the materials described above, and any other electrically conductive and dielectric materials can be used.

### C. Back-to-Back Baluns

This section describes the specific fabrication methods and parameters that were used to print the balun prototypes along with experimental characterization results.

### 1) Fabrication Process

Using the multimaterial AM system and the materials described above, the inventors fabricated several exemplary BTB baluns. These exemplary BTB baluns, shown in FIGS. 14A-14C, are based on the triple-tapered balun design illustrated in FIG. 10C. To allow for convenient experimental characterization, printed SMA connectors 1402a, 1402b (FIG. 14A) were integrated into each end of the BTB balun. The details of the printed connectors are known and can be found K. McParland, Z. Larimore, P. Parsons, A. Good, J. Suarez and M. S. Mirotznik, “Additive Manufacture of Custom Radiofrequency Connectors,” IEEE Transactions on Components, Packaging and Manufacturing Technology, Vol. 12, No. 1, pp. 168-173, January 2022.

With the addition of 5 mm connector-to-balun SMA sections 1402a, 1402b on each end of the BTB balun, the total balun length is 25 mm. The BTB baluns were printed vertically to resolve the fine features shown in FIGS. 14A-14C. Due to the extremely low viscosity and low solvent content of the silver paste, filling the conductive channels was performed after printing of all dielectric regions. The total print time for the exemplary BTB baluns was approximately 1 hour, but the invention is not limited to any particular print time duration or range thereof. Once the conductive regions were filled, the device was placed in an oven and post-cured at 130° C. for an additional hour to further cure the ink and improve the electrical conductivity.

To evaluate if the printed geometries were consistent with the desired designs, micro-CT imaging with a Rigaku GX 130 was performed (FIG. 14C). In this image, the dark regions depict the location of conductive ink and closely match the desired geometry of FIG. 14A. The micro-CT imaging also verified relatively low void content within the conductive regions using the conductive inks described above. The inventors have found that maintaining low void content within the printed conductive regions is critical for obtaining good RF properties.

### 2) Experimental Results

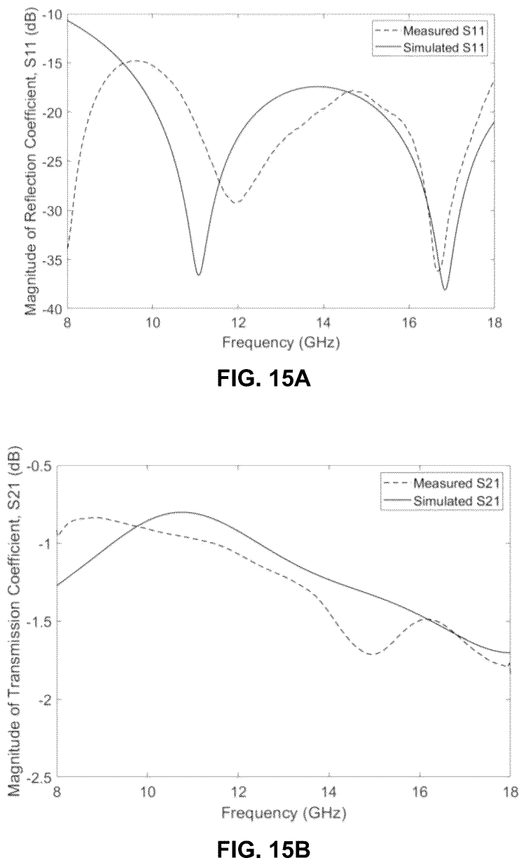

The S-parameters from the printed BTB baluns were measured using an Agilent E8361C vector network analyzer. After calibrating, the reflection and transmission coefficients were measured from 8 GHz to 18 GHz and compared to the simulated values. The results, shown in FIGS. 15A-15B, demonstrate a reasonably good match between predicted and measured results. The magnitude of the measured reflection coefficient, FIG. 15A, is below −15 dB over most of this frequency range with a maximum value of −11 dB at the lower frequencies. The measured transmission loss, illustrated in FIG. 15B, varies from −0.8 dB to −1.75 dB.

D. Integrated Balun with Spiral Antenna

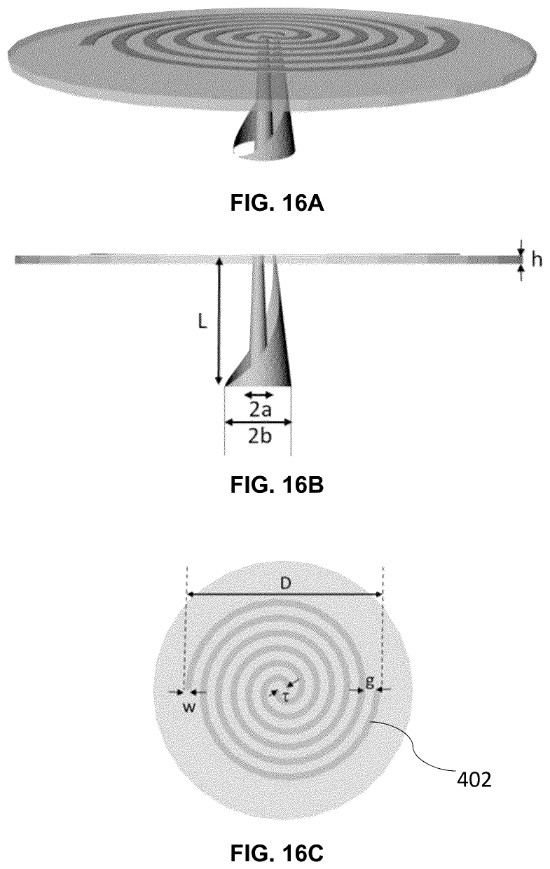

As additional validation, the present inventors designed, fabricated, and characterized a fully integrated feed that combines the multi-tapered coaxial balun with a threaded SMA connector and a spiral antenna. The device, illustrated in FIGS. 16A-16C and summarized in Table III below, employs the same triple-tapered balun design (FIG. 10C) used in the previous BTB prototype (FIG. 8) with an integrated SMA connector (best shown in FIG. 14A). The antenna is a simple 3-turn Archimedean spiral antenna with an input impedance at the antenna feed of approximately 160 2. It should be noted that the feed gap “T” (FIG. 16C) between the two feed points of the antenna 302, which are connected respectively to the second ends 210 (or 310) and 214 (or 314) of the inner and outer conductors 202 (or 302) and 204 (or 304), is less than 1.0 mm.

TABLE III
SPIRAL ANTENNA PARAMETERS

| | | |
|---|---|---|
| Arm width (w) | 1.25 | mm |
| Gap width (g) | 0.9 | mm |
| Spiral Diameter (D) | 29 | mm |
| Feed gap ( [symbol] ) | 0.95 | mm |
| Balun length (L) | 7.5 | mm |
| Sub. thickness ( [symbol] ) | 1.6 | mm |

| | |
|---|---|
| Sub. permittivity ( [symbol] ) | 1.75 |

[symbol]

indicates data missing or illegible when filed

### 1) Fabrication Process

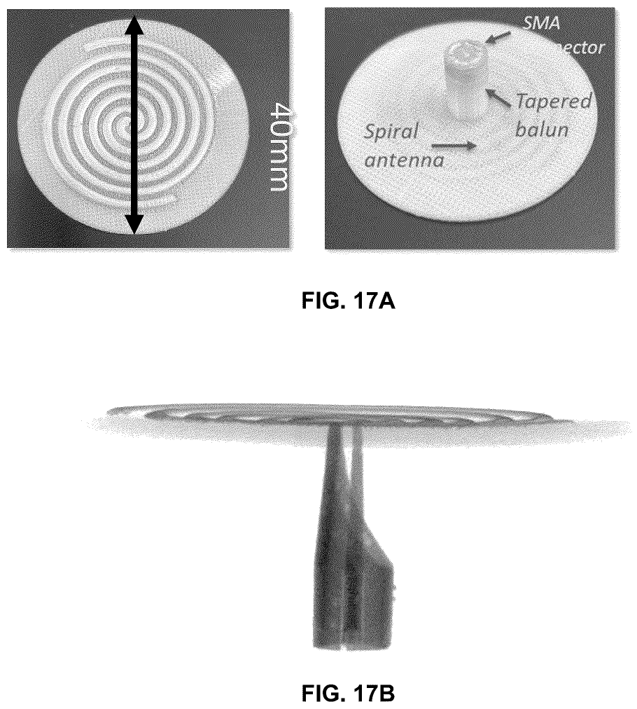

The integrated antenna feed was fabricated using the nScrypt™ Tabletop multi-material AM system. As with the BTB balun, all dielectric regions were fabricated using polycarbonate via FFF and all conductive regions were printed via micro-dispensing of silver inks. The entire feed structure was fabricated in two steps (FIG. 17A). First, an antenna substrate and a spiral antenna were printed with the spiral antenna printed on the top surface of the antenna substrate. Second, the printed antenna was flipped over (i.e., printed antenna on the bottom of the antenna substrate) and the balun and the SMA connector were printed vertically onto the antenna substrate and electrically connected to the spiral antenna through two small vias. After all conductive regions were filled with conductive inks, the components were post-cured in an oven at 130° C. for an hour. To evaluate how well the printed part matched the desired geometry, micro-CT imaging was performed on the entire antenna and balun (FIG. 17B). The micro-CT image verified the proper dimensions including but not limited to the small feed gap between the inner conductor and the outer conductor at the antenna-facing end of the triple-tapered balun.

### 2) Experimental Results

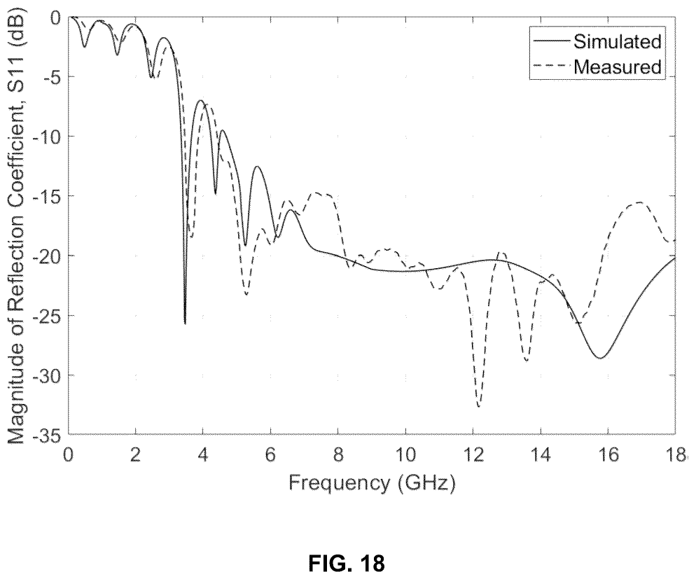

The return loss from the integrated balun with spiral antenna illustrated in FIGS. 17A and 17B was measured and compared to the simulated values. The results, shown in FIG. 18, show excellent agreement between the measured and the predicted results with a return loss of less than-10 dB between 8 GHz and 18 GHz. However, embodiments are not limited to this frequency range, and the triple-tapered balun geometry (FIG. 10C) can be used for any other frequency ranges.

The multi-tapered design of the coaxial balun system described herein is a novel structure for realizing wideband impedance transforming baluns with coaxial cross-sections by including tapering of one, or both, of the inner and outer conductor radii, in addition to varying the slot angle, or the slot width, within the outer conducting shield. This multi-tapered structure allows the spacing between, and the size of, the inner and outer conductors at the balanced end of the device (e.g., the antenna side) to be controlled independently of the dimensions at the unbalanced end (e.g., an unbalanced coaxial transmission line to a receiver, a transmitter, a transceiver, a low-noise amplifier (LNA), etc., for example, which provides the ability to design the balun to connect to any commercial or custom connectors and antennas. This multi-tapered structure provides additional design freedoms useful for achieving a range of impedance ratios, satisfying fixed geometrical constraints, and reducing transmission losses.

The multi-tapered design of the coaxial balun system described herein was experimentally fabricated by using advanced additive manufacturing methods, such as a multimaterial AM approach, for example. Experimental validation conducted within the X and Ku-band for both the printed BTB baluns and the fully integrated antenna feed, as well as simulated and measured results, demonstrated that the multi-tapered design of the coaxial balun system achieves a wider range of impedance contrast with balanced-to-unbalanced impedance ratios that range from 1:1 to greater than 5:1 (e.g., the impedance at the antenna end is more than five times larger than the impedance at the connector end) over a wide frequency range. This impedance range is not possible with the known coaxially tapered designs.

Although the invention is illustrated and described herein with reference to specific embodiments, the invention is not intended to be limited to the details shown. Rather, various modifications may be made in the details within the scope and range of equivalents of the claims and without departing from the invention.

1. A multi-tapered coaxial balun for use with an antenna, the balun comprising:
a coaxial transmission line including:
an inner conductor;
an outer conductor; and
a tapered slot provided within the outer conductor,
wherein at least one of the inner conductor or the outer conductor is tapered.

2. The multi-tapered coaxial balun of claim 1, wherein at least one of the inner conductor or the outer conductor is tapered at a respective end of the inner conductor or the outer conductor facing the antenna.

3. The multi-tapered coaxial balun of one of claim 1, further comprising a dielectric material provided between the inner conductor and the outer conductor.

4. The multi-tapered coaxial balun of claim 2, wherein both the inner conductor and the outer conductor are tapered.

5. The multi-tapered coaxial balun of claim 4, wherein both the inner conductor and the outer conductor are tapered at respective ends of the inner conductor and the outer conductor facing the antenna.

6. The multi-tapered coaxial balun of claim 1, wherein a slot taper of the tapered slot and respective taper of the at least one of the inner conductor or the outer conductor are configured to produce an impedance matching between an unbalanced end of the coaxial transmission line and the antenna along a length of the balun.

7. The multi-tapered coaxial balun of claim 6, wherein the impedance matching is achieved by varying a cross-sectional geometry of at least one of the inner conductor or the outer conductor the length of the balun.

8. The multi-tapered coaxial balun of claim 6, wherein a balanced-to-unbalanced impedance ratio is greater than 5:1.

9. The multi-tapered coaxial balun of claim 1, wherein the inner conductor has a gradually narrowing conical frustum shape comprising a first radius at a first end of the inner conductor, a second radius at a second end of the inner conductor, and varying radii along a length of the inner conductor, wherein the first radius is larger than the second radius.

10. The multi-tapered coaxial balun of claim 9, wherein the outer conductor has a gradually narrowing conical frustum shape comprising a third radius at a first end of the outer conductor, a fourth radius at a second end of the outer conductor, and varying radii along a length of the outer conductor, wherein the third radius is larger than the fourth radius.

11. The multi-tapered coaxial balun of claim 10, wherein the third radius is larger than the first radius.

12. The multi-tapered coaxial balun of claim 10, wherein the fourth radius is larger than the second radius.

13. The multi-tapered coaxial balun of claim 10, further comprising a feed gap between the second end of the inner conductor and the second end of the outer conductor.

14. The multi-tapered coaxial balun of claim 1, wherein a first end of the outer conductor comprises a circular arc with an arc dimension equal to a diameter of the outer conductor minus a dimension of the slot.

15. The multi-tapered coaxial balun of claim 14, wherein a space between the inner conductor and the circular arc is filled with a dielectric material.

16. The multi-tapered coaxial balun of claim 14, wherein a first end of the inner conductor has a first radius and the circular arc of the outer conductor has a second radius with a half angle.

17.-24. (canceled)

25. An antenna device comprising:
an antenna substrate;
an antenna;
a SubMiniature version A (“SMA”) connector; and
a multi-tapered coaxial balun including:
an inner conductor;
an outer conductor; and
a tapered slot provided within the outer conductor,
wherein at least one of the inner conductor or the outer conductor is tapered.

26. The antenna device of claim 25, wherein the multi-tapered coaxial balun and the SMA connector are printed vertically on a bottom surface of the antenna substrate.

27.-29. (canceled)

30. A method for producing an antenna device, the method comprising:
printing an antenna on a first surface of an antenna substrate;
printing a multi-tapered coaxial balun and a SubMiniature version A (“SMA”) connector on a second surface of the antenna substrate, the second surface of the antenna substrate being opposite the first surface of the antenna substrate; and
electrically connecting the multi-tapered coaxial balun and the SMA connector to the antenna,
wherein the multi-tapered coaxial balun includes:
an inner conductor;
an outer conductor; and
a tapered slot provided within the outer conductor,
wherein at least one of the inner conductor or the outer conductor is tapered.

31.-33. (canceled)

34. The method of claim 30, further comprising selecting an impedance profile that smoothly transitions from an unbalanced input impedance to a balanced load impedance over a length of the balun.

35.-39. (canceled)
